(19) United States
(12) Patent Application Publication
(10) Pub. No.: US 2012/0287131 A1
(43) Pub. Date: Nov. 15, 2012

(54) IMAGE PROCESSING APPARATUS AND IMAGE REGISTRATION METHOD

(75) Inventors: Kazuki Matsuzaki, Tachikawa (JP); Kumiko Seto, Fuchu (JP); Yoshihiko Nagamine, Hitachi (JP); Hajime Sasaki, Hachioji (JP)

(73) Assignee: HITACHI, LTD., Tokyo (JP)

(21) Appl. No.: 13/515,557

(22) PCT Filed: Dec. 16, 2010
(86) PCT No.: PCT/JP10/72628

§ 371 Date: Jul. 23, 2012

(30) Foreign Application Priority Data
Dec. 16, 2009 (JP) 2009-285242

(51) Int. Cl. G06K 9/32; G09G 5/377; G06T 15/06

(52) U.S. Cl. 345/426; 345/619; 345/629

(57) ABSTRACT

In the process of a registration between first and second images captured by different image pickup apparatuses, even if corresponding parts have different pixel values, different shapes and different field of view, the registration can be carried out with high speed and high degree of precision. In order to perform the registration between the first and second images, either of the first and second images is divided into segmented regions, and given physical property values are set to the segmented regions. Further, an image (pseudo image) having similar pixel values, shapes and field of view to the other image is created, and the pseudo image and the second image that have the same features are positioned, thereby performing the registration between the first and second images.

### TECHNICAL FIELD

The present invention relates to an image processing apparatus and in particular to an image registration technology for performing registration between images obtained by multiple image diagnosis apparatuses.

### BACKGROUND ART

Medical image diagnosis allows body information to be obtained noninvasively and thus has been widely performed in recent years. Three-dimensional images obtained by various types of image diagnosis apparatuses such as x-ray computer tomography (CT) apparatuses, magnetic resonance imaging (MRI) apparatuses, positron emission tomography (PET) apparatuses, and single photon emission computed tomography (SPECT) apparatuses have been used in diagnosis or follow-up. X-ray CT apparatuses generally can obtain images having less distortion and high spatial resolution. However, the images obtained do not sufficiently reflect histological changes in soft tissue. On the other hand, MRI apparatuses can render soft tissue with high contrast. PET apparatuses and SPECT apparatuses can convert physiological information such as metabolic level into an image and thus are called a functional image. However, these apparatuses cannot clearly render the morphology of an organ compared to x-ray CT apparatuses, MRI apparatuses, and the like. Ultrasound (US) apparatuses are small and have high mobility, and can capture an image in real time and in particular render the morphology and motion of soft tissue. However, the image pickup area thereof is limited depending on the shape of the probe. Further, a US image includes much noise and thus does not clearly show the morphology of soft tissue compared to images clearly showing the morphology, such as a CT image and MRI image. As seen, these image diagnosis apparatuses have both advantages and disadvantages.

Accordingly, registration between images obtained by multiple apparatuses (hereafter referred to as multi-modality images) allows compensation for the disadvantages of the respective images and utilization of the advantages thereof. This is useful in performing diagnosis, making a therapeutic plan, and identifying the target site during treatment. For example, registration between an x-ray CT image and a PET image allows a precise determination as to in what portion in what organ the tumor is located. Further, use of information on the body outline of the patient obtained from a CT image and information on the position of soft tissue obtained from a US image allows precise identification of the site to be treated, such as an organ or tumor.

Effective utilization of multi-modality images in diagnosis or treatment requires precise and easy registration between images. However, when images of the same subject are captured by multiple apparatuses, the images obtained do not have the same pixel value or the same distribution even at the same site. This is because the apparatuses have different image generation mechanisms. Further, the body outline of the subject or the morphology of an organ is clearly rendered in a CT image, MRI image, or the like, while the morphology is not clearly rendered in a US image, PET image, or the like. Furthermore, where the body outline or organ of the subject is not rendered in the field of view as in a US image, the corresponding site is not clear. This makes registration difficult.

In recent years, by utilizing the features of real-time image pickup by a US apparatus, registration is performed between a US image obtained by monitoring the current situation of the subject and a previously captured CT image while comparing these images. Thus, the position or size of the subject to be treated is monitored during operation. For example, in radio frequency ablation (RFA), treatment is performed while comparing a US image obtained during monitoring with a previously captured CT image. As seen, of multi-modality-image registration techniques, a technique of performing registration between an image obtained in real time and a previously captured, sharp morphology image with ease, high speed, and high degree of precision during operation is particularly increasingly needed.

Known conventional techniques used to perform registration between multi-modality images include (a) the manual method where the operator manually moves images to be positioned, (b) the point surface image overlay method where a feature or shape (point, straight line, curved surface) in images to be positioned is set manually or semi-automatically and corresponding features or shapes between the images are matched, (c) the voxel image overlay method where the similarity between the pixel values of the images is calculated and then registration is performed (Non-Patent Literature 1).

Another proposed method for performing registration between a CT image and an ultrasonic image is a method of generating a similar image to an ultrasonic image from a CT image and using it for registration (Non-Patent Literature 2).

### CITATION LIST

### Nonpatent Literature

Non-Patent Literature 1: Hiroshi Watabe, “Registration of Multi-modality Images,” Academic Journal of Japanese Society of Radiological Technology, Vol. 59, No. 1, 2003

Non-Patent Literature 2: Wolfgang Wein, et al., “Automatic CT-ultrasound Registration for Diagnostic Imaging and Image-guided Intervention,” Medical Image Analysis, 12, 577-585, 2008

Non-Patent Literature 3: Frederik Maes, et al., “Multi modality Image Registration by Maximization of Mutual Information,” IEEE Trans. Med. Image., Vol. 16, No. 2, 1997.

### SUMMARY OF INVENTION

### Technical Problem

A technique used to perform registration between multi-modality images is described in Non-Patent Literature 1. However, the manual method (a) has a problem that it takes time and effort, as well as a problem that registration precision depends on the subjective point of view of the operator. The point surface image overlay method (b) can automatically perform registration between images once the corresponding shapes are determined. However, automatic extraction of the corresponding points or surfaces requires manual determination of the corresponding shape. Accordingly, (b) has the same problem as (a). The voxel image overlay method (c) relatively easily performs registration between images compared to (c) and (b). However, the entire shape of the body outline of the subject must be rendered in the images to be positioned even when the voxel pixel values are different. For example, it is difficult to perform registration between an image where only part of the body outline of the subject or an organ is rendered, such as a US image, and a CT or MRI image where its entirety is rendered.

A technique related to registration between a CT image and an ultrasonic image of multi-modality images is described in Non-Patent Literature 2. However, soft tissue or the like not rendered on a CT image is not rendered on a similar image generated from the CT image, either. Accordingly, where the registration target is soft tissue, sufficient registration cannot be performed.

The main factor that makes it difficult to automatically perform registration between multi-modality images with high speed and high degree of precision is that the images to be positioned have different pixel values, rendered shapes, and field of view. For this reason, the operators have conventionally understood medical knowledge or the features of the image pickup apparatuses or obtained images in advance and then performed registration between the images while determining the corresponding positions therebetween.

An object of the present invention is to provide a processing apparatus and image registration method that, in registration between multi-modality images, can automatically with high speed and high degree of precision perform registration between images where the captured same site of the same subject is not rendered as having the same pixel value, shape, and field of view owing to the image pickup apparatuses being of different types.

### Solution to Problem

To accomplish the above-mentioned object, the present invention provides an image processing apparatus and method for performing registration between a plurality of images. The image processing apparatus includes a display unit that can display first and second images captured by different image pickup apparatuses; an input unit that inputs an instruction to perform processing on the second image; and a processing unit that performs processing on the second image. The processing unit generates a pseudo image by dividing the second image into predetermined regions, setting physical property values to the segmented regions, and calculating an image feature value of the first image, and performs registration between the first and second images using the generated pseudo image.

Further, there are provided an image processing apparatus and image registration method where, in the calculation of the pixel feature value from the second image, the processing unit further adds an additional area that is not present among the segmented regions, sets a physical property value to the additional area, and subsequently calculates the pixel feature value.

Further, there are provided an image processing apparatus and image registration method where, in the calculation of the pixel feature value from the second image, the processing unit uses theoretical physical property values corresponding to the segmented regions and area averages of pixel values of the segmented regions.

Specifically, for the purpose of accomplishing the above-mentioned object, in order to perform registration between the first and second images, the present invention generates, from one of the images (e.g., the second image), an image having a pixel value, shape, and field of view similar to those of the other image (e.g., the first image) (hereafter referred to as pseudo image) and performs registration between the first image and the pseudo image having the same image feature value as the first image. Thus, registration is performed between the first and second images. In the generation of this pseudo image, the second image is divided into predetermined segmented regions.

Further, in the process of generating the pseudo image, based on the distribution of one of the images (e.g., the second image), the present invention calculates the physical property (physical property value) distribution of the subject related to the generation mechanism of the image pickup apparatus of the other image (e.g., the first image).

Further, when an area having a different physical property distribution (divisional area) is not clearly rendered on the original image from which the physical property (physical property value) distribution has been calculated, the present invention adds the position and shape of the physical property area (additional area).

Further, the present invention calculates, from this physical property distribution, an image having a feature value similar to the pixel value, the rendered shape, and the field of view of the image (pseudo image) at high speed.

### Advantageous Effects of Invention

According to the present invention, in registration between the first and second images captured by different apparatuses, from one image, an image similar to the other image is generated at high speed. Thus, the pixel values, shapes, and field of views of the same site of the subject, which is an imaging target, can be easily compared. As a result, automatic, high-speed, and high degree of precision registration can be performed between the images.

Further, in the process of generating a similar image, an area to be positioned is specified in the original image and added thereto. Thus, registration with higher degree of precision can be performed between the images.

### BRIEF DESCRIPTION OF DRAWINGS

FIG. 1 is a diagram showing the overall configuration of a medical image registration system according to a first embodiment.

FIG. 2 is a diagram showing the flow of an image registration process according to the first embodiment.

FIG. 3A is a diagram showing an image area division process according to the first embodiment.

FIG. 3B is a diagram showing physical property value parameters set in the image area division process according to the first embodiment.

FIG. 4A is a diagram showing a pixel value tracking process (part 1) according to the first embodiment.

FIG. 4B is a diagram showing the pixel value tracking process (part 2) according to the first embodiment.

FIG. 4C is a diagram showing the pixel value tracking process (part 3) according to the first embodiment.

FIG. 5 is a graph showing a function for performing a convolution operation with a pixel value according to the first embodiment.

FIG. 6 is a diagram showing an example of a generated pseudo image according to the first embodiment.

FIG. 7 is a diagram showing a method for disposing a result of image registration on a monitor according to the first embodiment.

FIG. 8A is a diagram showing the specification of an area that is not rendered on an image according to the first embodiment.

FIG. 8B is a diagram showing physical property value parameters for setting the specification of an area that is not rendered on an image according to the first embodiment.

### DESCRIPTION OF EMBODIMENTS

Hereafter, embodiments of the present invention will be described in detail with reference to the drawings. In this specification, data on an image A and data on an image B may be referred to as image A data and image B data, first image data and second image data, or image data A and image data B, respectively.

### First Embodiment

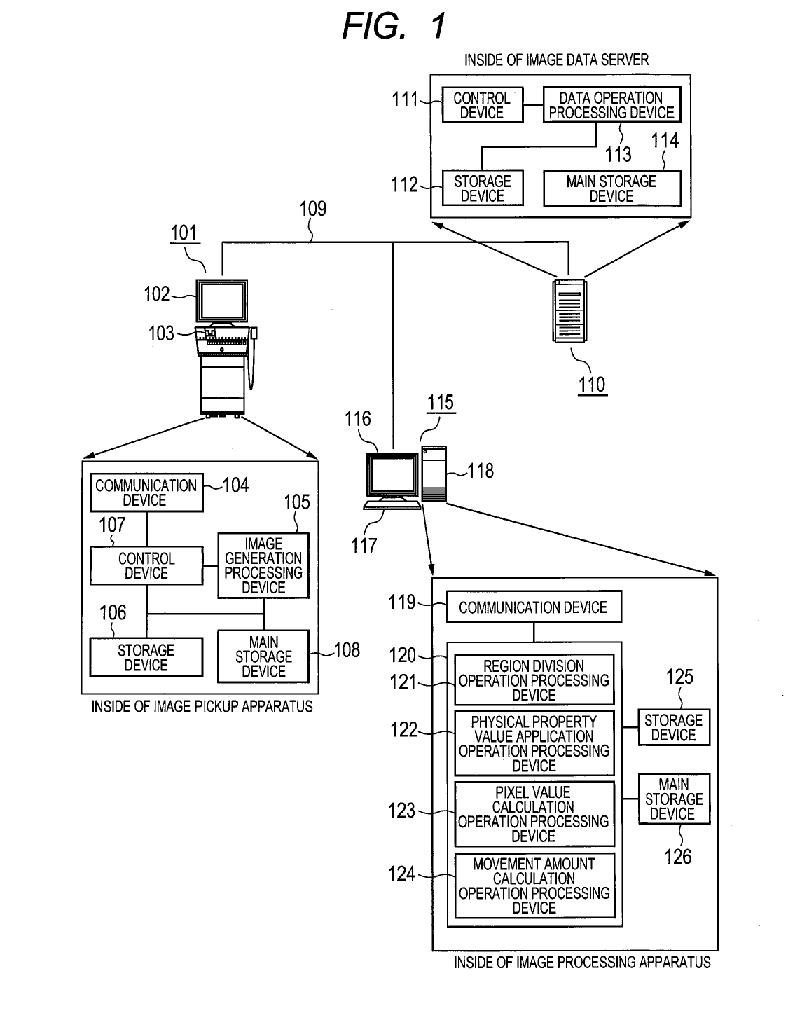

The overall configuration of an image registration system according to a first embodiment is shown in FIG. 1. First, devices included in the system will be described. An image pickup apparatus 101 serving as an image diagnosis apparatus includes a main body thereof, a monitor 102 serving as a display for displaying a captured image or parameters required for image capture, and input means 103 for giving an instruction to the image pickup apparatus 101 through a user interface displayed on the monitor 102. The input means 103 is typically a keyboard, mouse, or the like. A user interface which is typically used on the monitor 102 is a graphical user interface (GUI).

As shown, the main body of the image pickup apparatus 101 further includes a communication device 104 for communicating with the inside of the main body, an image generation processing device 105 for generating an image from image capture data, a storage device 106 for storing data such as a processing result or image or an image generation program, a control device 107 for controlling the main body and the image generation processing device 105 of the image pickup apparatus 101, and a main storage device 108 for, when performing an image generation operation, temporarily storing the image generation program stored in the storage device 106 and data required for processing. This configuration can be composed of a computer including an ordinary communication interface, a central processing unit (CPU) serving as a processing unit, and a memory serving as a storage unit. That is, the image generation processing device 105 and the control device 107 correspond to processing performed by the CPU.

An image data server 110 includes a communication device 111 connected to a network 109 and configured to exchange data with other apparatuses, a storage device 112 for storing data, a data operation processing device 113 for controlling the internal devices of the image data server 110 and performing on data an operation such as compression of the data capacity, and a main storage device 114 for temporarily storing a processing program used by the data operation processing device 113 or data to be processed. Needless to say, in the server 110 also, the data operation processing device 113 corresponds to the above-mentioned CPU serving as a processing unit, and the image data server 110 is composed of an ordinary computer.

The image pickup apparatus 101 can transmit a captured image to the image data server 110 via the communication device 104 and the network 109 and store image data in the storage device 112 in the image data server 110.

An image processing apparatus 115 includes an main body 118 thereof, a monitor 116 for displaying an operation result and a user interface, and input means 117 serving as an input unit used to input an instruction to the image registration main apparatus 118 via the user interface displayed on the monitor 116. The input means 117 is, for example, a keyboard, mouse, or the like.

The image processing device main body 118 further includes a communication device 11 for transmitting input data and an operation result, an image registration operation processing device 120, a storage device 125 for storing data and an image registration operation program, and a main storage device 126 for temporarily storing an operation program, input data, and the like so that they are used by the image registration operation processing device 120. The image registration operation processing device 120 includes an area division operation processing device 121 for performing an image registration operation, a physical property value application operation processing device 122, a device 123 for processing an operation for calculating a pixel value from a physical property value distribution, and a movement amount calculation operation processing device 124. Details of image registration operation processing performed by the image registration operation processing device 120 will be described later. Needless to say, in the image processing apparatus 115 also, the image registration operation processing device 120 of the main body 118 thereof corresponds to the above-mentioned CPU serving as a processing unit, and the image processing apparatus 115 is composed of an ordinary computer.

The image processing apparatus 115 can obtain an image to be positioned from the image pickup apparatus 101 or the image data server 110 via the communication device 119 and the network 109.

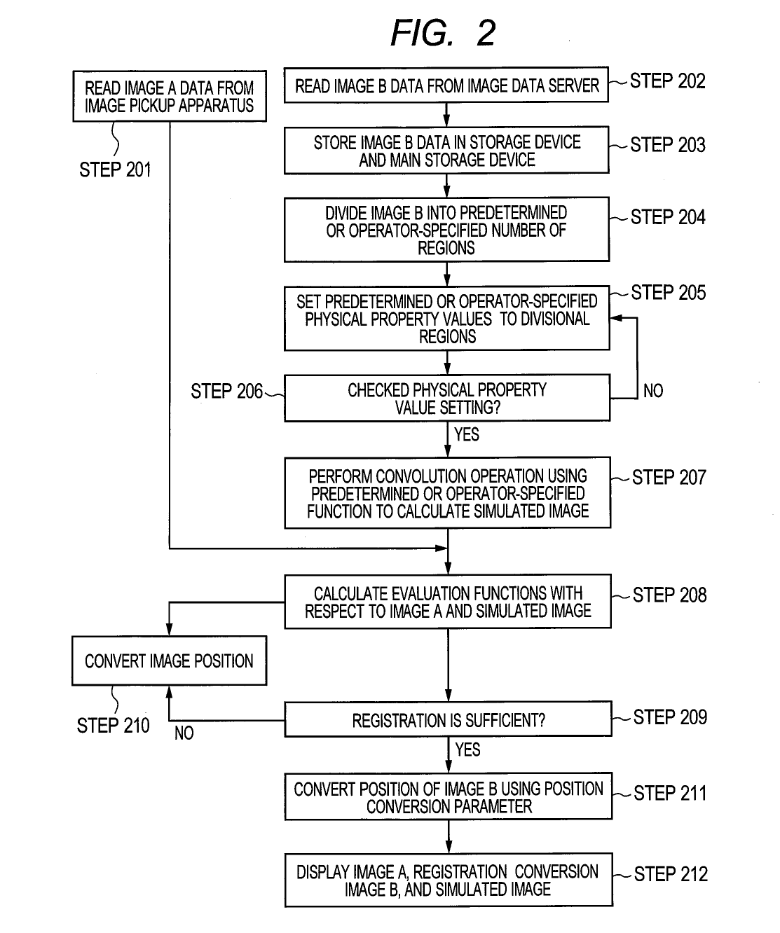

The flow of image registration in the image registration system according to the first embodiment will be described using FIG. 2. It is assumed that, of image data to be position contrasted, an image A captured by an ultrasound diagnostic apparatus serving as the image pickup apparatus 101 is an ultrasonic image and that an image B stored in the image data server 110 is a CT image. A case where the image processing apparatus 115 performs registration between these two images will be described as an example. In this specification, the image A and the image B are referred to as a first image and a second image, respectively.

First, an image of the target organ or affected site, which is the subject, is captured using the image pickup apparatus 101. The ultrasonic image A generated by the image generation processing device 105 is stored in the storage device 106. The CT image B having an image capture area including the area whose image has been captured by the image pickup apparatus 101 is stored in the image data server. The image processing apparatus 115 reads the ultrasonic image A from the image pickup apparatus 101 and the CT image B from the image data server 110 via the network 109 (steps 201 and 202) and stores them in the storage device 125 and the main storage device 126 (step 203).

It is assumed that the first image, the image A, stored in the storage device 106 of the image pickup apparatus 101 and the second image, the image B, stored in the storage device 112 of the image data server 110 are in the format of a standard, Digital Imaging and Communication in Medicine (DICOM), which is generally used in the field of the image pickup apparatus.

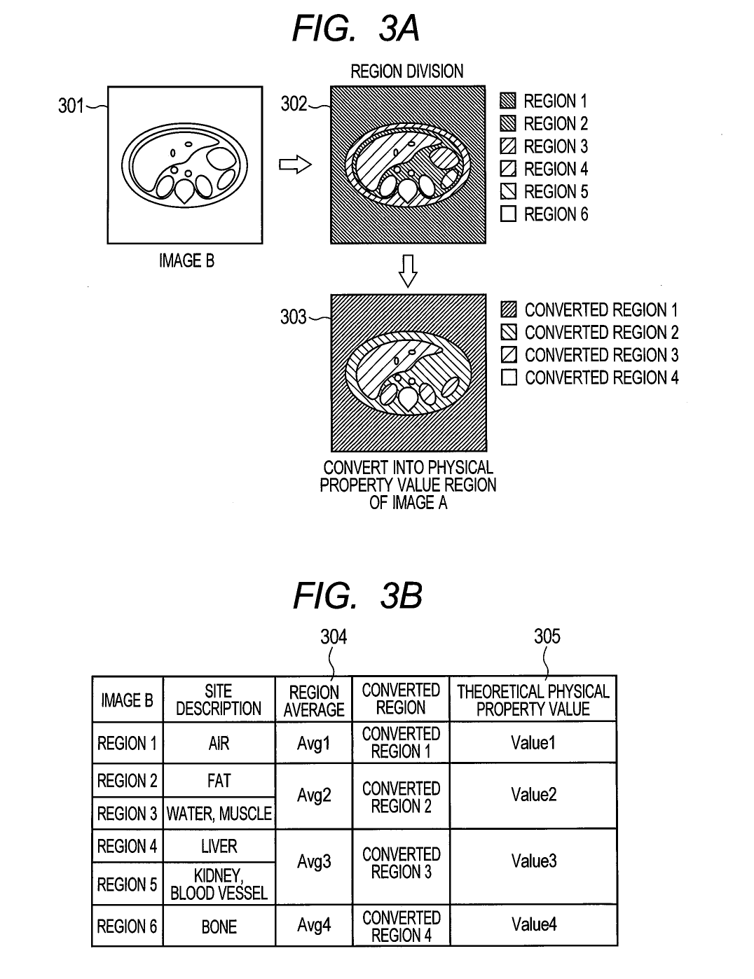

In this embodiment, to perform registration between the image A and the image B, the second image, the image B, is first divided into regions on a main organ basis (step 204). The method for dividing the image B into regions will be described using FIGS. 3A and 3B.

Where the image capture site is, e.g., the stomach, the second image, an image B301, is divided into five regions, that is, the regions of air, soft tissue, organ, blood vessel, and bone, or six regions, as shown in FIGS. 3A and 3B. FIG. 3A shows an image 302 that is divided into regions 1 to 6, which correspond to site descriptions of air, fat, water and muscle, liver, kidney and blood vessel, and bone, as shown in FIG. 3B.

The most common of the methods for dividing into regions is the method of previously setting the upper and lower thresholds on the basis of pixel values and then dividing into regions using the thresholds. However, where the imaging conditions are different; the image pickup apparatuses are of different types; or the subjects are different, the pixel value at the same site varies. Accordingly, the same upper and lower thresholds cannot always be applied. Failure to skillfully divide into regions would affect the shape of the organ appearing on a pseudo image, as well as reduce registration precision. Accordingly, proper division into regions is required.

Techniques of calculating the upper and lower thresholds of a pixel value in accordance with the distribution of pixel values include the clustering method. The clustering method is a technique of, in accordance with a specified number of segmented regions, calculating the median of a region so that the differences between the median and the values distributed on the periphery of the area are minimized. This technique allows the upper and lower thresholds to be calculated in accordance with the difference between the pixel values of the subject. In this embodiment, the clustering method is used as one technique for accomplishing high-precision area division even when the image pickup conditions or the subjects are different.

The number of segmented regions can optionally be set by the operator. For example, the number of organs rendered on the image varies depending on the image pickup site. Accordingly, the image may be divided into a larger number of regions, or the number of segmented regions may be limited. As long as the image B is divided into at least two regions, the regions can be used for registration.

Next, physical property value parameters for calculating similar features on the basis of the generation mechanism of the image A are set to the segmented regions (step 205). Since theoretical physical property values of sites of a human body of ultrasound are already known, the physical property values can be set to the segmented regions, as shown in FIG. 3B. However, if the physical property values are set to the segmented regions as they are, fine changes in pixel value of the image B would be lost, making all pixel values in the area uniform.

For this reason, in this embodiment, to utilize the distribution of pixel values in the segmented regions, a physical property value f new (x, y) set from the original pixel value f (x, y) on the basis of the following formula using the area averages (Avg1 to Avg4) 304 of the pixel values of the regions and theory physical property values (Value1 to Value4) 305 shown in FIG. 3B are calculated. Thus, an image feature value is calculated. In the example shown in FIG. 3B, the area 2 and area 3, and the area 4 and the area 5 are each regarded as one area, and an area average (Avg) and a theory physical property value (value) are set to these regions.

$${f}_{new} ( x , y ) = w \cdot Value [ i ] + ( 1 - w ) \cdot \frac{Value [ i ]}{Avg [ i ]} \cdot f ( x , y ) \qquad [ Formula 1 ]$$

Here, w is a parameter that can perform control as to what extent the original pixel value distribution should be considered. This makes it possible to set physical property values in consideration of the pixel value distribution of the image B itself. As a result, an image 303 having features similar to those of the image A can be obtained. At this time, the operator determines whether the above-mentioned area division and physical property value setting are sufficient (step 206). If not sufficient, the operator can return to step 205 and repeatedly perform area division, physical property value setting, and pixel feature value calculation. With respect to a distribution image of the physical property value f new (x, y) thus calculated, pixels on a straight line are tracked. Then, using a convolution operation, a pixel value distribution (pseudo image) similar to that of the image A is calculated (step 207).

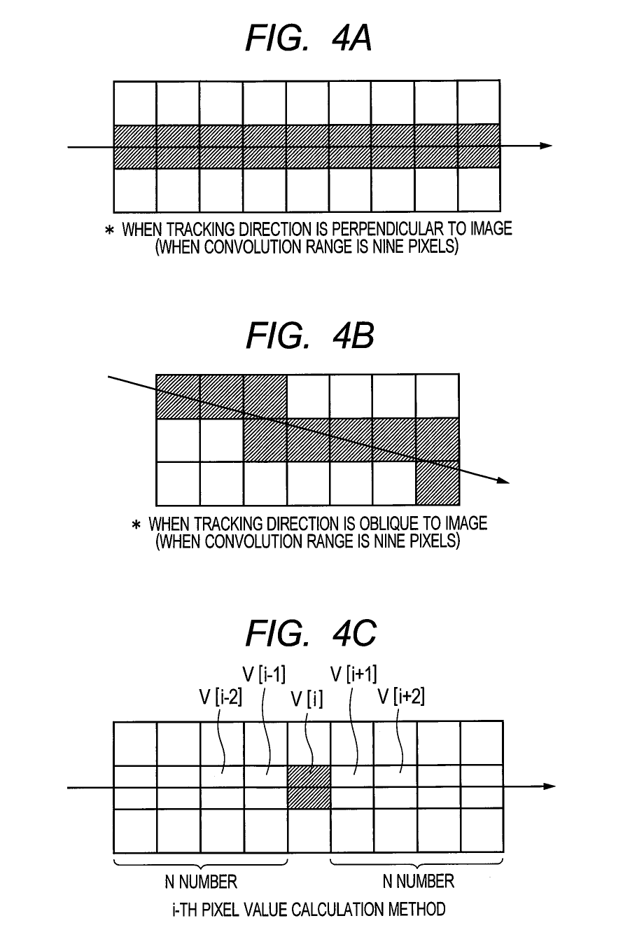

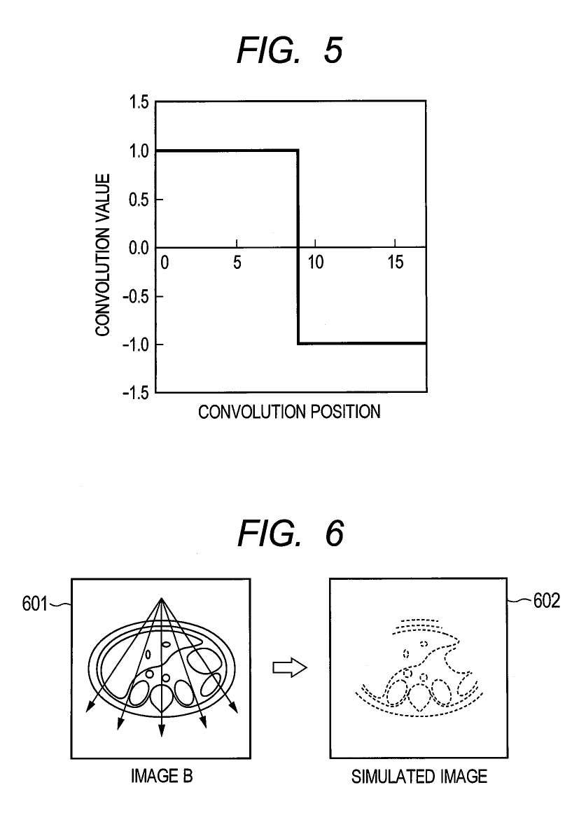

Next, using FIGS. 4A to 4C, ray tracing will be described as one example of the method for tracking pixel values in this embodiment. A virtual straight line is considered with respect to the physical property value distribution image, and attention is given to pixels where the straight line crosses the image. Where the straight line perpendicularly crosses the image in a direction from the left of the image as in FIG. 4A, 2N+1 number (in FIG. 4A, nine) of pixels (gray) can be extracted. If attention is given to pixels that the straight line passes through, 2N+1 number of pixels can be extracted even in a case where the straight line obliquely crosses the image in a direction from the left of the image as in FIG. 4B, as in the case where the straight line perpendicularly crosses the image. The pixel values of the 2N+1 number of pixels extracted are stored in the main storage device 126 of the image processing apparatus 115. The i-th pixel value on the pseudo image is calculated on the basis of the following formula using the 2N+1 number of pixel values ( . . . , V[i−1], V[i], V[i+1], . . . ) stored in the main storage device 126 as shown in FIG. 4C and the values of convolution functions, convolution values ( . . . , g[i−1], g[i], g[i+1], . . . ), illustrated in FIG. 5 (step 207).

I(x,y)=Σ_{n=-N}^{N}(V(i+n)·g(i+n)) [Formula 2]

A pseudo image of I(x, y) obtained from the above-mentioned operation on the basis of image data B601 has high pixel values on boundaries where there is a large difference between the physical property values as shown in 602 of FIG. 6, and a pixel value distribution similar to that of the image A is obtained. Further, as shown in the figure, only a field of view similar to that of the first image, the image A, can be converted into an image.

The value of N can optionally be set by the operator. If the image pickup apparatus 101 is an ultrasonic apparatus, a value according the frequency of ultrasound can be set. With respect to the range to which the above-mentioned calculation is to be applied, the field of view to be position-contrasted can be set or changed.

An example where calculation is performed in a section in FIGS. 4A to 6, that is, an example where a sectional image is generated has been described as calculation for obtaining a pseudo image shown in step 207 of FIG. 2. However, this calculation where a pseudo image is obtained using ray tracing is also applicable to calculation where a straight line is assumed with respect to a three-dimensional image and pixel values are tracked, that is, calculation where a three-dimensional pseudo image is obtained.

Next, in step 208 of FIG. 2, evaluation functions are calculated with respect to the first image, the image data A, and the pseudo image generated from the second image, the image data B and then the evaluation functions are compared. For this purpose, the widely known mutual information maximization method described in Non-Patent Literature 3 can be used. The mutual information maximization method is a method for obtaining the similarity between two images. In this embodiment, the similarity between the image data A and the image data B is calculated, and an image position conversion parameter having the largest similarity is calculated. Generally, the mutual information maximization method is often applied to images having different pixel value features. This method takes more time than a technique of exploring the amount of movement using the least squares method with respect to a pixel value at the corresponding position of an image to be compared or a technique of exploring the amount of movement having a high pixel value correlation coefficient. On the other hand, in this embodiment, with respect to the first image, the image data A, a pseudo image is generated on the basis of the second image, the image data B, and the features of the pixel values are correlated. Accordingly, calculating the amount of movement using the above-mentioned least squares method or the correlation coefficient allows registration to be performed at higher speed.

Image registration is more preferably performed as follows. That is, each time an evaluation function is calculated, the operator determines whether registration is sufficient (step 209). If not sufficient, the operator converts the image position (step 210) and returns to the evaluation function calculation step to repeat the above-mentioned operation. If registration is sufficient, the operator completes the operation. The position conversion parameter obtained in this image position conversion is stored in the main storage device 126.

Since the pseudo image according to this embodiment is originally generated from the image data B, the positional correspondence between the image data B and the pseudo image is uniquely determined. For this reason, the processing unit such as the CPU applies the position conversion parameter obtained with respect to the image data A and the pseudo image to the second image, the image data B, obtains data on the registered second image, registered image data B (step 211), and stores it in the main storage device 126. If necessary, the data on the registered second image, the registered image data B, may be stored in a storage device of the main body 118 of the image processing device, the storage device 125. In the last step of the processing flow performed by the processing unit of FIG. 2, step 212, the image data A, which is the first image, the registered image data B, which is the registered second image, and the pseudo image are displayed on the monitor 116.

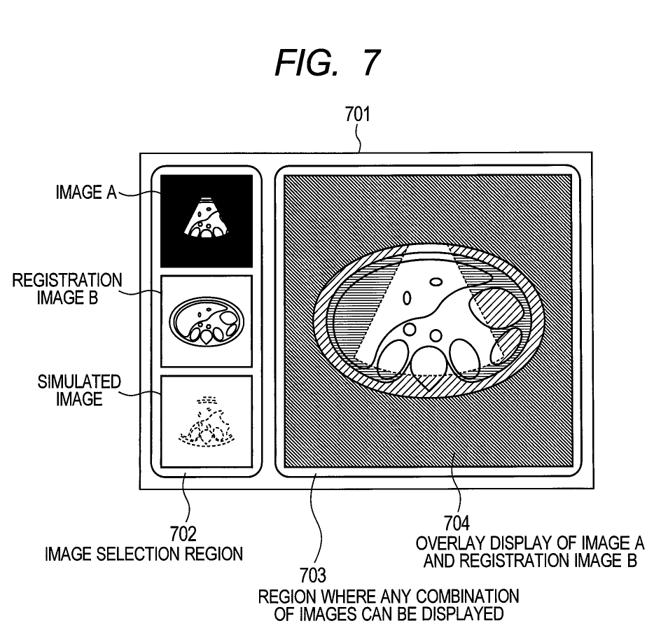

An example of a screen displayed on the monitor according to this embodiment will be described using FIG. 7. As shown in FIG. 7, the operator can give an instruction through the input unit so that any combination of the image data A, the registered image data B, and the pseudo image data is selectively displayed and check the registration result while displaying these pieces of data on the monitor in an overlaid manner. In this figure, 701 represents a monitor screen, 702 image selection area, 703 an area where any combination of the images can be displayed, and 704 an example of overlay display of the image data A and the registered image data B.

As described above in detail, according to the image registration system and the image registration method provided in this embodiment, high-speed, high-precision image registration can be accomplished by generating a pseudo image even when the same site of the subject, which is an imaging target, has different pixel values, shapes, or field of views in images obtained by different image pickup apparatuses.

Various modifications can be made to the configuration described in the above-mentioned first embodiment without impairing the functions thereof. In this embodiment, the image pickup apparatus 101, the image data server 110, and the image processing apparatus 115 have been described as separate apparatuses; however, these apparatuses may be configured as a single apparatus, that is, as a single computer including programs corresponding to the functions thereof. Further, some of the above-mentioned apparatuses or functions may be configured as a single apparatus, that is, as a single computer. For example, the image pickup apparatus 101 and the image processing apparatus 115 may be configured as a single apparatus.

Further, in the first embodiment, the DICOM format is used as the format of the image data A transmitted from the image pickup apparatus 101 to the image processing apparatus 115 and as the format of the image data B transmitted from the image data server 110 to the image processing apparatus 115; however, other formats such as a JPEG image and a bitmap image may be used.

Further, the configuration where the image data server 110 stores data files is used in the first embodiment; however, the image pickup apparatus 101 and the image processing apparatus 115 may directly communicate with each other to exchange a data file. Furthermore, image files may be stored in the main storage device 126 of the image processing apparatus 115 rather than storing them in the image data server 110. While the configuration where communication of a data file or the like via the network 109 is used has been described, other storage media, for example, transportable large-capacity storage media such as a floppy disk® and a CD-R, may be used as means that exchanges a data file.

While the ultrasonic apparatus has been described as the image pickup apparatus 101 in the above-mentioned embodiment, this embodiment can also be applied to apparatuses other than the ultrasonic apparatus, such as an endoscopic device, as it is by only changing the convolution function when generating a pseudo image. Since the pseudo image can be calculated as a three-dimensional image in step 206 as described above, this embodiment is applicable even when images to be positioned are three-dimensional images.

### Second Embodiment

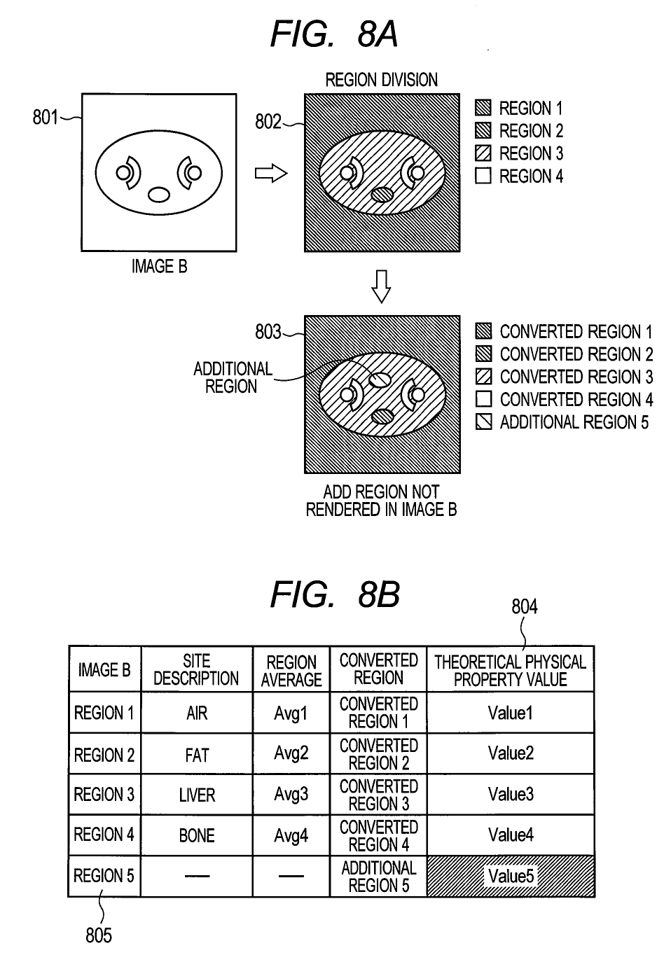

Next, a method where, in step 205 of FIG. 2, the operator newly specifies an area which is not rendered in the image and sets a physical property value to the area will be described as a second embodiment using FIGS. 8A and 8B. The operator additionally specifies an area (additional area 5) in an image 802 which is obtained by dividing image data B801 into regions, using the input means 117 via a user interface displayed on the monitor 116 by the operator. Thus, an image 803 can obtained. A physical property value (values) is set to the specified area. Thus, even when the site of interest rendered in the image data A, such as an organ or disease site, is not rendered in the image data B, the site of interest can be rendered in the pseudo image generated in step 206 by adding the shape and physical property thereof to the image B using the above-mentioned method. Since the site of interest is rendered on the pseudo image, registration precision can be improved by performing registration between the image A and the pseudo image.

Various methods such as free hand and polygon shape can be used as the method for specifying the additional area 5. While the area is specified in a section in FIGS. 8A and 8B, a three-dimensional area extending over multiple sections can be specified.

### INDUSTRIAL APPLICABILITY

The present invention relates to an image processing apparatus and is particularly useful as an image registration technology for performing registration between images obtained by multiple image diagnosis apparatuses.

### REFERENCE SIGNS LIST

101 . . . image pickup apparatus
102 . . . monitor
103 . . . input means
104 . . . communication device
105 . . . image generation processing device
106 . . . storage device
107 . . . control device
108 . . . main storage device
109 . . . network
110 . . . image data server
111 . . . communication device
112 . . . storage device
113 . . . data operation processing device
114 . . . main storage device
115 . . . image processing apparatus
116 . . . monitor
117 . . . input means
118 . . . operation device
119 . . . communication device
120 . . . image registration operation device
121 . . . area division operation processing device
122 . . . physical property value application operation processing device
123 . . . pixel value calculation operation processing device
124 . . . movement amount calculation operation processing device
125 . . . storage device
126 . . . main storage device

1. An image processing apparatus which performs registration between a plurality of images, comprising:
a display unit that can display first and second images captured by different image pickup apparatuses;
an input unit that inputs an instruction to perform processing on the second image; and
a processing unit that performs processing on the second image,
characterized in that the processing unit generates a simulated image by dividing the second image into predetermined regions, setting physical property values to the segmented region, and calculating an image value of the first image and physical property values, and performs registration between the first and second images using the simulated image.

2. The image processing apparatus according to claim 1, characterized in that, in the calculation of the image feature value from the second image, the processing unit further adds an additional area which is not present among the segmented regions, sets a physical property value to the additional area, and subsequently calculates the image feature value.

3. The image processing apparatus according to claim 1, characterized in that, in the calculation of the image feature value from the second image, the processing unit uses theoretical physical property values corresponding to the segmented regions and area averages of pixel values of the segmented regions.

4. The image processing apparatus according to claim 1, characterized in that, in the generation of the pseudo image, the processing unit applies ray tracing to the image feature value.

5. The image processing apparatus according to claim 1, characterized in that the processing unit performs control so that the first image and the pseudo image are displayed simultaneously on the display unit.

6. The image processing apparatus according to claim 1, characterized in that the processing unit calculates a registered second image using the second image and performs control so that the registered second image and the first image are displayed on the display unit in an overlaid manner.

7. The image processing apparatus according to claim 1, characterized in that the processing unit calculates a registered second image using the second image and performs control so that the first image, the registered second image, and the pseudo image are selectively displayed on the display unit.

8. A method for performing registration between images in an image processing apparatus including a display unit that can display first and second images captured by different image pickup apparatuses and a processing unit that performs processing on data on the second image, the method characterized by comprising:
generating a pseudo image by dividing the second image into predetermined areas, setting physical property values to the segmented regions, and calculating an image feature value of the first image; and
performing registration between the first and second images using the generated pseudo image.

9. The method for performing registration between images according to claim 8, characterized in that, in the calculation of the image feature value from the second image, an additional area that is not present among the segmented regions is further added, a physical property value is set to the additional area, and subsequently the image feature value is calculated.

10. The method for performing registration between images according to claim 8, characterized in that, in the calculation of the image feature value from the second image, theoretical physical property values corresponding to the segmented regions and area averages of pixel values of the segmented regions are used.

11. The method for performing registration between images according to claim 8, characterized in that, in the generation of the pseudo image, ray tracing is applied to the image feature value.

12. The method for performing registration between images according to claim 8, characterized in that the first image and the pseudo image are displayed simultaneously on the display unit.

13. The method for performing registration between images according to claim 8, characterized in that a registered second image is calculated using the second image, and the registered second image and the first image are displayed on the display unit in an overlaid manner.

14. The method for performing registration between images according to claim 8, characterized in that a registered second image is calculated using the second image, and the first image, the registered second image, and the pseudo image are selectively displayed on the display unit.

15. The method for performing registration between images according to claim 8, characterized in that the first image is an ultrasonic image, and the second image is an image captured by an x-ray CT apparatus.
